(19) United States
(12) Patent Application Publication
(10) Pub. No.: US 2014/0111162 A1
(43) Pub. Date: Apr. 24, 2014

(54) Method for operating a storage device for storing electrical energy, and storage device for storing electrical energy

(71) Applicants: Alexander Osswald, Stuttgart (DE); Thomas Heinrich, Nellmersbach (DE); Rainer Glauning, Leinfelden-Echterdingen (DE); Holger Claus, Stuttgart (DE)

(72) Inventors: Alexander Osswald, Stuttgart (DE); Thomas Heinrich, Nellmersbach (DE); Rainer Glauning, Leinfelden-Echterdingen (DE); Holger Claus, Stuttgart (DE)

(21) Appl. No.: 14/113,610

(22) PCT Filed: Mar. 12, 2012
(86) PCT No.: PCT/EP2012/054267

§ 371 Date: Jan. 6, 2014

(30) Foreign Application Priority Data
Apr. 27, 2011 (DE) 10 2011 017 599.7

(51) Int. Cl. H02J 7/00

(52) U.S. Cl. CPC H02J 7/007
USPC 320/134; 320/160

(57) ABSTRACT

A method for operating a storage device for storing electrical energy, having at least two storage cells. The storage cells are charged with the aid of a physical charge quantity provided by an electrical charging device, and a physical variable is monitored in each case in the storage cells. As a function of the monitored variables, a control signal is transmitted to the charging device for controlling same, and the charge quantity is successively reduced as a function of the control signal. A related storage device for storing electrical energy is also described.

### FIELD OF THE INVENTION

The present invention relates to a method for operating a storage device for storing electrical energy. Moreover, the present invention relates to a storage device for storing electrical energy.

### BACKGROUND INFORMATION

It is believed to be understood that during a charging operation of an accumulator which includes multiple storage cells, a temperature and/or a voltage in the storage cells is/are measured. If the temperature or the voltage in one of the cells increases above an allowable value, the charging operation is terminated, for example by switching off an electrical charging current which is provided with the aid of a charging device.

A particular disadvantage of such charging processes is believed to be that, for storage cells having different filling levels or states of charge, the storage cell having the highest filling level is generally the first to reach the switch-off temperature or switch-off voltage, whereupon the charging operation is terminated. At that time, however, the other storage cells have not yet reached their maximum possible filling level. In this regard, the accumulator in sum has a state of charge or filling level which is below its maximum possible state of charge. Multiple storage cells, each having a different filling level, are usually also referred to as unbalanced cells.

### SUMMARY OF THE INVENTION

An object of the present invention may therefore be regarded as providing a method for operating a storage device, having at least two storage cells, for storing electrical energy, which overcomes the known disadvantages and which allows the highest possible filling level, even for unbalanced storage cells.

Moreover, the object of the present invention may be regarded as providing a corresponding storage device for storing electrical energy.

These objects are achieved by the subject matter described herein. Advantageous embodiments are the subject matter of the further descriptions herein.

According to one aspect, a method for operating a storage device for storing electrical energy is provided. The storage device includes at least two storage cells. In this regard, the storage cells are charged with the aid of a physical charge quantity provided by an electrical charging device. During the charging operation, a physical variable in the individual storage cells is monitored. As a function of the monitored physical variables, a control signal which is able to control the charging device is then transmitted to the charging device. The charge quantity is successively reduced as a function of this control signal.

According to another aspect, a storage device for storing electrical energy is provided which has at least two storage cells. The storage cells may be charged with the aid of a physical charge quantity provided by an electrical charging device. In addition, the storage device includes a monitoring device which monitors a physical variable in the individual storage cells. Furthermore, a control device for outputting a control signal, which is a function of the monitored variables, for controlling the electrical charging device is provided in order to successively reduce the charge quantity.

The present invention thus includes the concept of carrying out a measurement of physical variables of the storage cells in the storage device itself. In this regard, the physical variable is monitored internally in the storage cells, i.e., within the storage device. Thus, the measured values in the storage cells are not externally conducted from the storage device to the charging device, which then appropriately carries out external monitoring. The physical variable may in particular be a function of a state of charge (which may also be referred to as a filling level) of the storage cell. If this physical variable increases above a predefined value, this predefined value corresponding, for example, to a maximum state of charge of the storage cell, the control device outputs a control signal to the charging device, and in this regard controls the charging device in such a way that the charging device successively reduces the physical charge quantity.

Within the meaning of the present invention, “successively” means in particular that the charging device does not reduce, i.e., switch off, the physical charge quantity to zero units in one step. Instead, in this case the charge quantity is in particular continuously reduced. In particular, the charge quantity is reduced to a minimum charge value which is greater than zero units of the physical charge quantity. In particular, the charge quantity is reduced to zero only if it has previously been successively reduced to the minimum charge value. That is, in particular the charging operation is terminated by the charging device only if the physical charge quantity has reached the minimum charge value.

In particular as a result of the successive reduction of the charge quantity, the physical variable in the storage cell in which the physical variable previously increased above a predefined value once again drops below this predefined value, so that this storage cell may also be safely recharged with the aid of the reduced charge quantity. In particular, a lower voltage now falls at an internal resistance of the cell, so that a cell voltage drops, whereupon the control device in particular resets its control signal. The other cells in which the physical variable was not above a predefined value are accordingly likewise further charged with the aid of the reduced charge quantity. In the related art, the charging process was already terminated at this point, so that the storage cells in which the physical variable was below the predefined value were no longer further charged, although they had not yet reached their maximum possible filling level. In this regard, according to the method according to the present invention, which may also be referred to as a charging process, the storage device according to the present invention has a higher filling level in comparison to the known storage devices which have been charged according to the known charging processes.

Within the meaning of the present invention, unbalanced storage cells refer in particular to storage cells which have different filling levels, that is, in particular that a storage cell has a higher or a lower filling level. An unbalanced storage cell may also include a defective storage cell which, for example, can no longer be completely charged.

In another specific embodiment, the storage device may be formed as an accumulator (battery). An accumulator may also be referred to as a battery pack. For example, the storage device may be formed as a lead accumulator, a lithium-ion accumulator, a lithium-polymer accumulator, a lithium-iron phosphate accumulator, a lithium titanate accumulator, a sodium-nickel chloride accumulator, a sodium-sulfur accumulator, a nickel-iron accumulator, a nickel-cadmium accumulator, a nickel-metal hydride accumulator, a nickel-hydrogen accumulator, a nickel-zinc accumulator, or a tin-sulfur-lithium accumulator.

According to one specific embodiment, the storage cells may be a galvanic cell. In conjunction with accumulators, such a galvanic cell may also be referred to as a secondary cell.

The physical variable may be a temperature in the storage cell and/or an electrical voltage in the storage cell. Such a temperature may also be referred to as a storage cell temperature. Such a voltage may also be referred to as a storage cell voltage.

In another specific embodiment, more than two storage cells are formed. The storage cells may be connected in series, for example, in particular for increasing a voltage provided with the aid of the storage cells, or may be connected in parallel, in particular for increasing an overall capacity of the storage cells. For example, it may also be provided that some storage cells are connected in parallel and some storage cells are connected in series, it being possible in turn to connect the parallel-connected storage cells to the series-connected storage cell in parallel or in series. It may be provided that the physical variable must first increase above a predefined value in multiple storage cells in order to output a corresponding control signal for successively reducing the charge quantity.

According to one specific embodiment, the storage cells are charged with the aid of the constant current constant voltage (CCCV) charging process.

According to another specific embodiment, it may be provided that the storage cells are at least partially discharged as a function of the control signal. As a result, in particular the physical variables in the individual storage cells drop further, so that, even if the successive reduction of the charge quantity is not sufficient to safely continue the charging operation, this is once again possible after the at least partial discharge. In particular, this discharging process may be carried out with the aid of an electronics system situated in the storage device. For example, a discharging current may be approximately 1 A, and in particular the discharging process is carried out for a period of several seconds, in particular approximately 1 s.

According to another specific embodiment, the electrical physical charge quantity is an electrical charging current. The electrical physical charge quantity may also be an electrical charge voltage with the aid of which the storage cells may be inductively charged. In particular, the inductive specific embodiment offers the advantage that charging contacts and charging plugs may be dispensed with, which reduces costs and technical manufacturing effort, for example.

According to another specific embodiment, the charge quantity is reduced, at least partially, corresponding to a step function. Such a step reduction takes place up to the predefined minimum charge value, which in particular may generally be approximately 100 mA. Within the meaning of the present invention, a step reduction means in particular that the charge quantity is reduced quasi-instantaneously to a lower value. A variation over time of such a step reduction has a staircase shape. In particular, the charge quantity may be reduced in steps corresponding to 1 A.

According to another specific embodiment, it may be provided that the charge quantity is reduced, at least partially, corresponding to an exponential function, that is, in particular that the variation over time of the physical charge quantity is proportional to the exponential function. In this regard, further parameters may be provided in the exponential function in particular as exponents and also as a proportionality factor.

In another specific embodiment, the control signal may be transmitted by tuning a temperature signal (NTC). Since the charging device in particular measures a temperature of the storage device, the control signals may thus be transmitted via the corresponding temperature sensor. In another specific embodiment not shown, the control signal may also be transmitted to the charging device in a wired and/or wireless manner.

According to another specific embodiment, the control device and the monitoring device may be integrally formed. That is, in particular the control device is integrated into the monitoring device. In particular an electronic device may be formed which includes a control device as well as a monitoring device. Such an electronic device may be formed as an integrated circuit, for example.

The present invention is explained in greater detail below based on exemplary embodiments and with reference to the figures.

### BRIEF DESCRIPTION OF THE DRAWINGS

FIG. 1 shows a flow chart of a method for operating a storage device for storing electrical energy.

FIG. 2 shows a storage device for storing electrical energy.

FIG. 3 shows a variation over time of a cell voltage and of a charging current in a storage device according to the related art.

FIG. 4 shows a variation over time of two storage cell voltages and a variation over time of a charging current in a storage device according to the present invention when the two storage cells are unbalanced.

FIG. 5 shows a variation over time of two storage cell voltages and a variation over time of a charging current in a storage device according to the present invention when the two storage cells are not unbalanced.

### DETAILED DESCRIPTION

Identical reference numerals are used for the same features below.

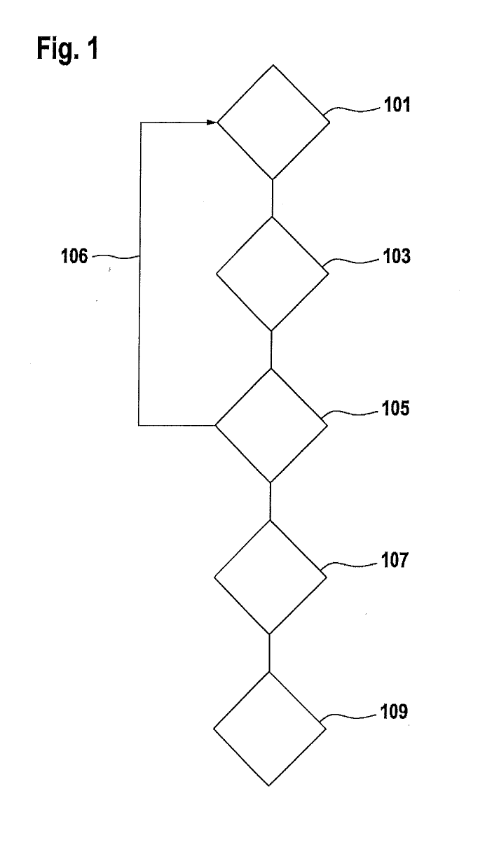

FIG. 1 shows a flow chart of a method for operating a storage device for storing electrical energy, the storage device having at least two storage cells. The storage cells are charged in a first step 101 with the aid of a physical charge quantity, in particular an electrical charging current and/or an electrical charging voltage for inductively charging the storage cells. The physical charge quantity is provided with the aid of an electrical charging device, not shown. A physical variable in the storage cells is monitored internally in the storage device in a step 103. The physical variable may be the storage cell temperature and/or the storage cell voltage.

An evaluation of the monitored physical variables then takes place in a step 105. If it is determined in this evaluation step 105 that the physical variables are below a predefined value, the charging operation is continued in step 101, which is denoted here by an arrow having reference numeral 106.

However, if it is determined in evaluation step 105 that the monitored physical variable is above a predefined maximum value at least in one storage cell, a control signal is transmitted to the charging device in a step 107, the control signal controlling the charging device in such a way that the charging device successively reduces the charge quantity in a step 109. After the charge quantity has been successively reduced, the charging process begins anew with step 101, except that now, the storage cells are charged with the aid of the successively reduced charge quantity.

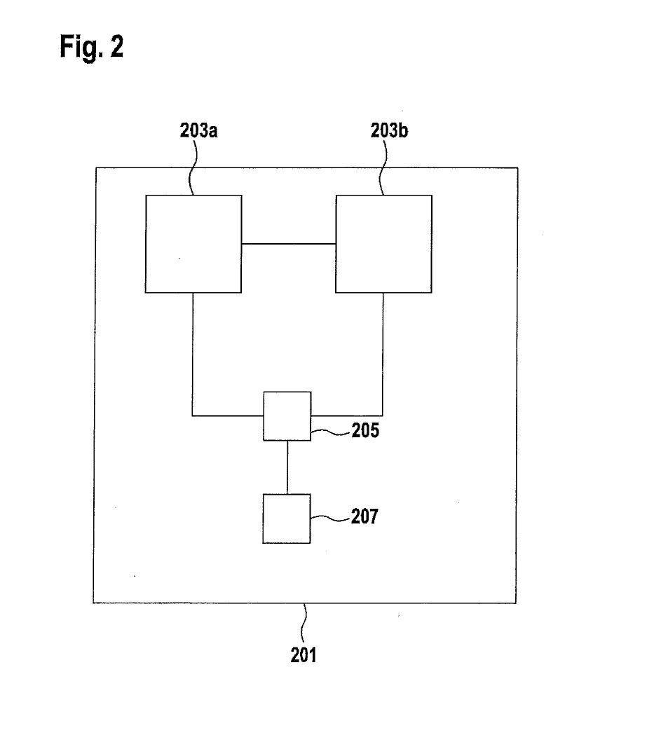

FIG. 2 shows a storage device 201 which includes two storage cells 203a and 203b. In one specific embodiment, not shown, more than two storage cells may also be provided. The two storage cells 203a and 203b may be charged with the aid of a physical charge quantity which is provided by a charging device, not shown. Storage device 201 also includes a monitoring device 205, which internally with respect to storage device 201 in each case monitors a physical variable in storage cells 203a, 203b. The physical variable may in particular be the storage cell temperature and/or the storage cell voltage.

In addition, storage device 201 includes a control device 207 which, as a function of the monitored variables, outputs a control signal to an electrical charging device, not shown, for controlling same in order to control the charging device in such a way that it successively reduces the physical charge quantity.

In one specific embodiment, not shown, monitoring device 205 and control device 207 may also be integrally formed; i.e., in particular control device 207 is integrated into monitoring device 205.

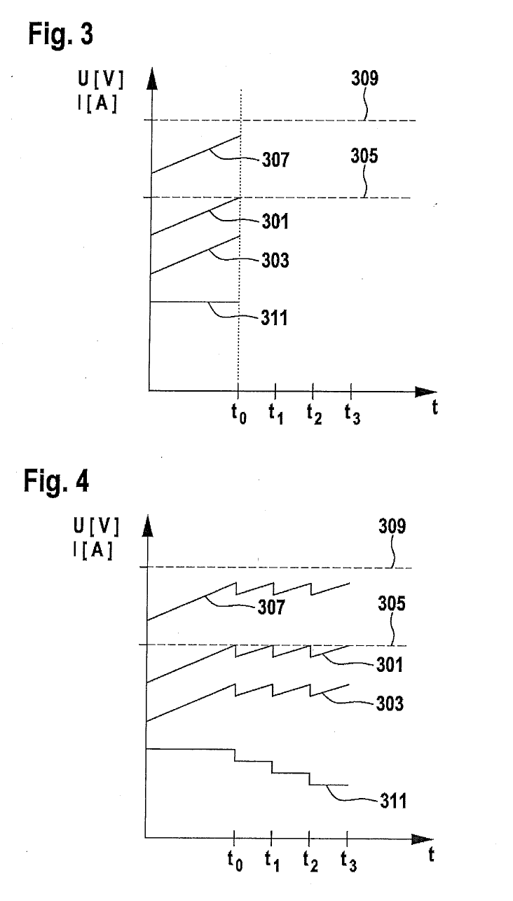

FIG. 3 shows a variation over time of two storage cell voltages, which are denoted here by reference numerals 301 and 303. A maximum allowable value for the storage cell temperature is denoted by reference numeral 305. In addition, the graph in FIG. 3 shows the variation over time of the total voltage of the storage device, which is denoted here by reference numeral 307. A maximum allowable value for the total voltage of the storage device is denoted by reference numeral 309. The variation over time of the charging current is denoted by reference numeral 311. In this regard, the two cells are charged according to the known charging processes, as described in greater detail below.

The two storage cell voltages 301 and 303 are different. This involves unbalanced storage cells. That is, in particular a filling level in the storage cell corresponding to storage cell voltage 301 is higher than a filling level in the storage cell corresponding to storage cell voltage 303. In this regard, in terms of time, storage cell voltage 301 will increase above maximum allowable value 305 before storage cell voltage 303. As soon as this is the case, the charging current is reduced to 0 A at point in time to, and in this regard the charging operation is terminated. Thus, although the storage cell corresponding to storage cell voltage 303 has not yet reached its maximum possible filling level, the charging operation is terminated. In this regard, the overall filling level of the storage device is unnecessarily low.

FIG. 4 shows the variation over time of the corresponding voltages and currents in a storage device according to the present invention which is operated with the aid of the method according to the present invention. Here as well, the storage cells are unbalanced, as shown in particular by the fact that the two storage cell voltages 301 and 303 are different. Consequently, storage cell voltage 301 will reach maximum allowable voltage value 305 at point in time t0. However, in contrast to the related art, charging current 311 is not reduced to 0 A; instead, at point in time t0 the charging current is successively reduced to a value which is above 0 A and below the starting charging current value. As a result, in particular storage cell voltage 301 once again drops below maximum allowable voltage value 305, so that the storage cell may also be safely further charged corresponding to storage cell voltage 301. Due to the further charging operation, at a point in time t1 storage cell voltage 301 is once again increased to a level at which it increases above maximum allowable value 305. Charging current 311 is once again successively reduced, so that storage cell voltage 301 thus once again falls below maximum value 305. This process is repeated until the charging current has reached a minimum charge value, for example 100 mA, at a point in time t3, whereupon the charging operation is then terminated; i.e., in particular the charging current is reduced to 0 A at point in time t3.

In FIG. 4, charging current 311 is reduced corresponding to a step function. FIG. 4 shows three steps, for which in each case charging current 311 is reduced by one step, in particular by 1 A. In another specific embodiment, not shown, more or fewer steps may also be provided. The number of current steps depends in particular on the maximum charging current; for example, for a maximum charging current of 6 A, in each case charging current 311 is reduced by 1 A at each step.

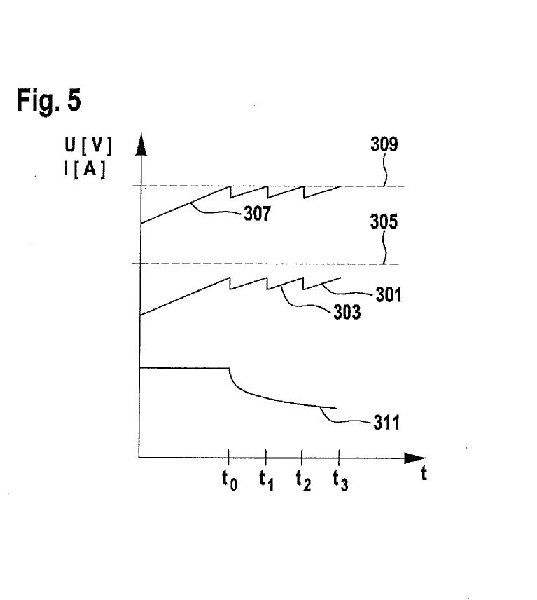

In another specific embodiment, not shown, it may also be provided that charging current 311 is successively reduced corresponding to an exponential function, as shown in FIG. 5.

FIG. 5 likewise shows the variations over time of the individual voltages and current flows. In contrast to FIG. 4, however, the two storage cells are not unbalanced; i.e., they are balanced. That is, in particular the storage cells have the same filling level or state of charge, so that storage cell voltage 301 and storage cell voltage 303 are equal.

Thus, in summary the present invention includes in particular the concept that in the battery pack the cell voltage and/or the cell temperature is/are measured and internally evaluated in the battery pack. Depending on the evaluation, a control signal is then transmitted to the charging device in order to successively reduce the charging current and/or the charging voltage. Thus, according to the present invention the battery pack controls the charging device.

1-6. (canceled)

7. A method for operating a storage device for storing electrical energy, having at least two storage cells, which are charged with the aid of a physical charge quantity provided by an electrical charging device, the method comprising:
monitoring a physical variable in the at least two storage cells;
transmitting, as a function of the monitored variables, a control signal for controlling the charging device to the charging device; and
successively reducing the charge quantity as a function of the control signal.

8. The method of claim 7, wherein the storage cells are at least partially discharged as a function of the control signal.

9. The method of claim 7, wherein the electric physical charge quantity is at least one of an electrical charging current and an electrical charging voltage for inductively charging the storage cells.

10. The method of claim 7, wherein the charge quantity is reduced, at least partially, corresponding to a step function.

11. The method of claim 7, wherein the charge quantity is reduced, at least partially, corresponding to an exponential function.

12. A storage device for storing electrical energy, comprising:
at least two storage cells, which are chargeable with the aid of a physical charge quantity provided by an electrical charging device;
a monitoring device to monitor a physical variable in each case in the storage cells; and
a control device to output a control signal, which is a function of the monitored variables, to control the electrical charging device to successively reduce the charge quantity.
